(19) United States
(12) Patent Application Publication
(10) Pub. No.: US 2013/0227000 A1
(43) Pub. Date: Aug. 29, 2013

(54) Server Apparatus For Providing Contents To Terminal Devices

(71) Applicant: YAMAHA CORPORATION, (US)

(72) Inventor: Yuji KOIKE, Yokohama-shi (JP)

(73) Assignee: YAMAHA CORPORATION, Hamamatsu-shi (JP)

(21) Appl. No.: 13/777,771

(22) Filed: Feb. 26, 2013

(30) Foreign Application Priority Data
Feb. 27, 2012 (JP) 2012-039656

(51) Int. Cl. H04L 29/06

(52) U.S. Cl. CPC H04L 67/42
USPC 709/203

(57) ABSTRACT

In a server apparatus for providing content to terminal devices, a receiver receives from a first terminal device indication information that indicates processing to be performed on content data representing content. An acquisition unit acquires content data of the content as a processing target. A processor performs the processing indicated by the indication information on the content data. A storage unit identifies the content data by identification information, and stores the content data in correspondence to the identification information as unprocessed content data and stores the content data on which the processing has been performed as processed content data. A transmission controller transmits the unprocessed content data identified by the identification information to a second terminal device when the second terminal device requests the content data in order to edit the content.

### BACKGROUND OF THE INVENTION

1. Technical Field of the Invention

The present invention relates to a server apparatus for providing content.

2. Description of the Related Art

Recently, a service that provides content such as music through the Internet has been offered. Technologies for providing content are disclosed in patent references 1 to 3. Patent reference 1 describes a technique of transmitting data using a content package. Patent reference 2 discloses a technique of coding content using an algorithm based on importance of content. Patent reference 3 describes a technique of providing a preview version and commercial version of content to a user.
[Patent Reference 1] Japanese Patent Application Publication No. 2001-231018
[Patent Reference 2] Japanese Patent Application Publication No. 2000-348003
[Patent Reference 3] Japanese Patent Application Publication No. 2001-042866

A user may edit existing content to create new content. However, the techniques described in patent references 1 to 3 do not provide content in a form that is easily edited, and thus it is impossible to easily edit content according to the conventional techniques.

### SUMMARY OF THE INVENTION

An object of the present invention is to provide content in a form that is easily edited.

The present invention provides an apparatus for providing content to terminal devices, comprising: a receiver configured to receive from a first terminal device indication information that indicates processing to be performed on content data representing content; an acquisition unit configured to acquire content data of the content as a processing target; a processor configured to perform the processing indicated by the indication information received by the receiver on the content data acquired by the acquisition unit; a storage unit configured to identify the content data acquired through the acquisition unit by identification information, and configured to store the content data in correspondence to the identification information as unprocessed content data and to store the content data on which the processing has been performed as processed content data; and a transmission controller configured to transmit the unprocessed content data identified by the identification information to a second terminal device when the second terminal device requests the content data representing the content in order to edit the content.

In a preferred aspect of the present invention, the transmission controller is configured to transmit the processed content data being identified by the identification information and being stored in the storage unit to the second terminal device when the second terminal device requests the content data representing the content in order to play back the content.

In another preferred aspect of the present invention, the storage unit is configured to associate the indication information with the identification information of the content data on which the processing indicated by the indication information is performed and configured to store the indication information in correspondence to the identification information, and the transmission controller is configured to transmit to the second terminal device the content data as unprocessed content data together with the indication information corresponding to the identification information identifying the content data stored in the storage unit and requested by the second terminal device.

In a preferred aspect of the present invention, the content data is composed of a plurality of pieces of track data representing a plurality of tracks of the content, and the indication information indicates processing performed on the track data. In such a case, the processor is configured to perform the processing indicated by the indication information on the track data constituting the content data acquired by the acquisition unit. The storage unit is configured to identify the track data by track identification information, and is configured to store the track data as unprocessed track data in correspondence to the track identification information and to store the track data on which the processing indicated by the indication information is performed as processed track data. The transmission controller is configured to transmit, to the second terminal device, the unprocessed track data constituting the content data when the second terminal device requests the content data representing the content in order to edit the content, and configured to transmit data corresponding to a mixture of the processed track data identified by the track identification information and stored in the storage unit when the second terminal device requests the content data representing the content in order to play back the content.

Specifically, the content data represents music and the plurality of track data represents a plurality of parts of the music.

The present invention also provides a terminal device for editing content data representing content provided from a server apparatus, comprising: a graphical user interface configured to display a control enabling a user to select either of editing or playback of content; a communication interface configured to transmit a first request to the server apparatus when the editing of the content is requested by the user and to receive first content data of the content from the server apparatus in response to the first request, and configured to transmit a second request to the server apparatus when the playback of the content is requested by the user and to receive second content data of the content from the server apparatus in response to the second request, the first content data and the second content data representing the same content but respectively having a first format and a second format different from each other, the first format being designed for editing of the content and the second format being designed for playback of the same content; an editing unit configured to edit the first content data of the first format displayed on the graphical user interface when the editing of the content is selected, and configured to upload the edited first content data to the server apparatus; and a playback unit configured to play back the second content data of the second format when the playback of the same content is selected.

In a preferred aspect of the present invention, the communication interface is configured to receive the first content data that is composed of a plurality of track data representing a plurality of tracks of the content, and the editing unit is configured to selectively edit one or more of the plurality of track data and configured not to edit the remaining track data, and is configured to upload only the edited track data and to notify the server apparatus of the remaining track data.

The present invention further provides a method of providing content to terminal devices, comprising: receiving from a first terminal device indication information that indicates processing to be performed on content data representing content; acquiring content data of the content as a processing target; performing the processing indicated by the indication information on the content data; identifying the content data by identification information; storing the content data in correspondence to the identification information as unprocessed content data; storing the content data on which the processing has been performed as processed content data; and transmitting the unprocessed content data identified by the identification information to a second terminal device when the second terminal device requests the content data in order to edit the content.

According to the present invention, it is possible to provide content in a form suitable for editing.

### BRIEF DESCRIPTION OF THE DRAWINGS

FIG. 1 shows a configuration of a system for providing content according to an embodiment of the invention.

FIG. 2 is a block diagram illustrating a configuration of a server apparatus.

FIG. 3 illustrates a management structure of content data.

FIG. 4 illustrates song information.

FIG. 5 illustrates track information.

FIG. 6 is a block diagram illustrating a client device.

FIG. 7 is a block diagram illustrating a functional configuration of the server apparatus.

FIG. 8 is a sequence chart illustrating a music playback process.

FIG. 9 shows an exemplary content list screen.

FIG. 10 is a sequence chart illustrating a music editing process.

FIG. 11 shows an exemplary editing screen.

FIG. 12 is a view for explaining a voice synthesis process.

FIG. 13 is a sequence chart illustrating a music registration process.

FIG. 14 illustrates a content data management structure.

FIG. 15 illustrates a content data management structure according to a modification.

FIG. 16 illustrates a content data management structure according to another modification.

### DETAILED DESCRIPTION OF THE INVENTION

1. Configuration

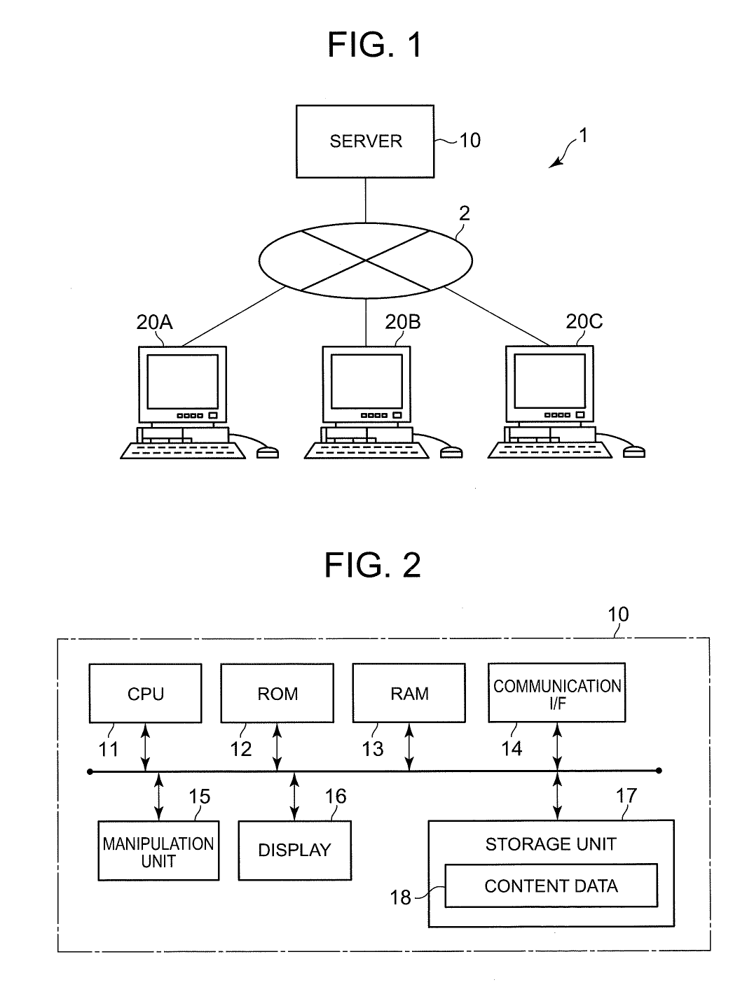

FIG. 1 shows a configuration of a system 1 for providing content according to an embodiment of the invention. The system 1 for providing content includes a server apparatus 10 (e.g. content providing apparatus) and a plurality of client devices 20. FIG. 1 shows client devices 20A, 20B and 20C from among the plurality of client devices 20 that is a terminal device. The client devices 20 are terminal devices connected to the server apparatus 10 through a communication network 2, for example, the Internet.

FIG. 2 is a block diagram illustrating a configuration of the server apparatus 10. The server apparatus 10 includes a CPU (Central Processing Unit) 11, a ROM (Read Only Memory) 12, a RAM (Random Access Memory) 13, a communication interface (communication I/F) 14, a manipulation unit 15, a display 16, and a storage unit 17. The CPU 11 controls the components of the server apparatus 10 by executing a program. The ROM 12 is a read only memory storing a basic system program executed by the CPU 11. The RAM 13 is a volatile memory used as a work area by the CPU 11. The communication interface 14 controls data communication between the server apparatus 10 and the client devices 20. The manipulation unit 15 includes a keyboard and a mouse, for example. The manipulation unit 15 supplies a manipulation signal corresponding to manipulation of a user to the CPU 11. The display 16 is a liquid crystal display panel, for example. The display 16 displays various images under control of the CPU 11. The storage unit 17 is a hard disk, for example. The storage unit 17 stores content data 18 that represents a plurality of pieces of music (e.g. content). The CPU 11 has a function of performing various types of sound processing on the content data 18. The storage unit 17 stores data necessary for sound processing.

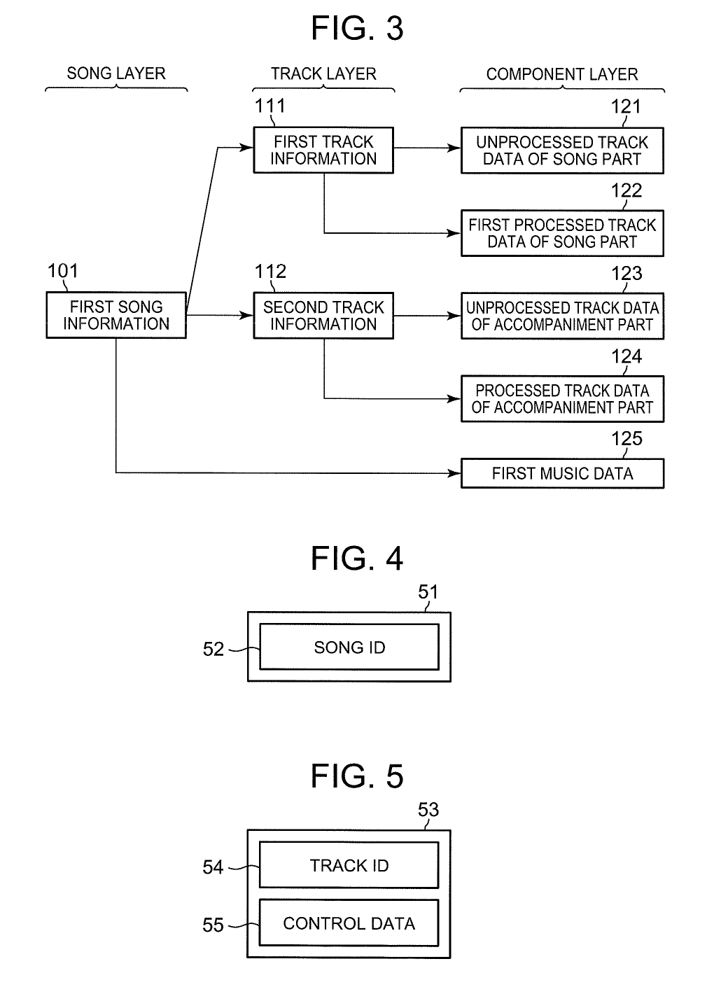

FIG. 3 illustrates a management structure of the content data 18. The content data 18 is managed as three layers, a song layer, a track layer and a component layer. The song layer stores song information. FIG. 4 illustrates the song information 51. The song information 51 has a song ID 52 for identifying the content data 18. The track layer stores track information. FIG. 5 illustrates the track information 53. The track information 53 includes a track ID 54 and control data 55. The track ID 54 is information for identifying track data that constitutes the content data 18. The control data 55 is indication information that indicates sound processing performed on track data. When sound processing is not performed on the track data, the track information 53 does not include the control data 55.

Referring back to FIG. 3, this shows the management structure of the content data 18 representing music m1. The content data 18 is multi-track data composed of track data recorded in a first track and track data recorded in a second track. The first track stores track data corresponding to a song part (part of the music) of the music m1. Voice synthesis processing using the voice of a singer G is set to the first track as sound processing performed on the track data. The second track stores track data corresponding to an accompaniment part (also part of the music) of the music m1. Effect processing is set to the second track as sound processing performed on the track data.

In this case, the component layer stores unprocessed track data 121 and first processed track data 122 of the song part, unprocessed track data 123 and processed track data 124 of the accompaniment part, and first music data 125. Both the unprocessed track data 121 and the processed track data 122 correspond to track data representing the song part of the music m1. The unprocessed track data 121 is data before voice synthesis processing set to the first track is performed. The first processed track data 122 corresponds to data after voice synthesis processing set to the first track is performed. Specifically, the unprocessed track data 121 is score information t1 in a MIDI format, which represents the score of the song part of the music m1. The score information t1 includes musical notes that constitute the song part of the music m1 and data that represents time series of the lyrics of the music m1. The first processed track data 122 is audio data generated by performing voice synthesis processing using the voice of the singer G on the basis of the score information t1. Both the unprocessed track data 123 and the processed track data 124 of the accompaniment part correspond to track data that represents the accompaniment part of the music m1. The unprocessed track data 123 is data before effect processing set to the second track is performed. The processed track data 124 is data after the effect processing is performed. Specifically, the unprocessed track data 123 is audio data t2 that represents the accompaniment part of the music m1. The processed track data 124 is obtained by performing the effect processing on the audio data t2. The first music data 125 is audio data that represents the music m1. The first music data 125 is obtained by mixing the first processed track data 122 and the processed track data 124.

First track information 111 and second track information 112 are stored in the track layer. The first track information 111 includes a first track ID and first control data. The first track ID is identification information that identifies the first track. The first control data is indication information that indicates voice synthesis processing set to the first track. The second track information 112 includes a second track ID and second control data. The second track ID is information that identifies the second track. The second control data is information that indicates effect processing set to the second track. The first track information 111 includes a link to the unprocessed track data 121 and a link to the first processed track data 122. The second track information 112 includes a link to the unprocessed track data 123 and a link to the processed track data 124. First song information 101 is stored in the song layer. The first song information 101 includes a first song ID. The first song ID is information for identifying the music m1. The first song information 101 includes a link to the first track information 111, a link to the second track information 112 and a link to the first music data 125.

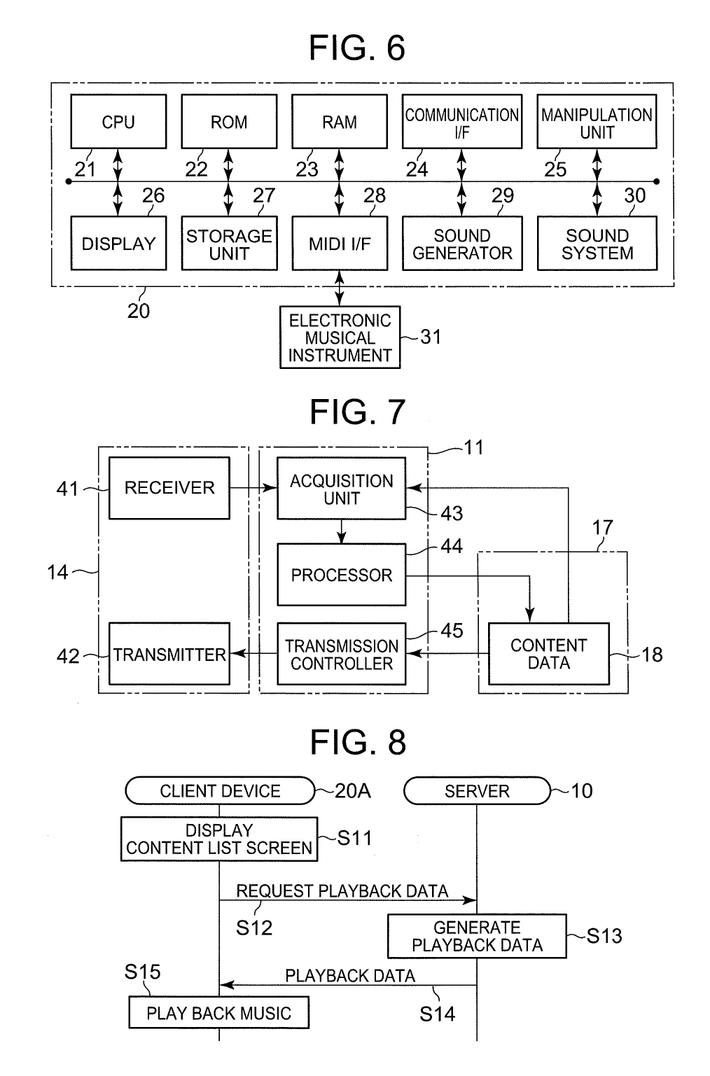

FIG. 6 shows a configuration of a client device 20. The client device 20 includes a CPU 21, a ROM 22, RAM 23, a communication interface (communication I/F) 24, a manipulation unit 25, a display 26, a storage unit 27, a MIDI interface (MIDI I/F) 28, a sound generator 29, and a sound system 30. The CPU 21 controls the components of the client device 20 by executing a program. The ROM 22 is a read only memory in which a basic system program executed by the CPU 21 is stored. The RAM 23 is a volatile memory used as a work area by the CPU 21. The communication interface 24 controls data communication between the client device 20 and the server apparatus 10. The manipulation unit 25 includes a keyboard and a mouse, for example. The manipulation unit 25 provides a manipulation signal corresponding to manipulation of a user to the CPU 21. The display 26 is a liquid crystal display panel, for example. The display 26 displays various images under control of the CPU 21. The storage unit 27 is a hard disk, for example. The storage unit 27 stores various types of data. The MIDI interface 28 controls exchange of a MIDI signal between the client device 20 and an electronic musical instrument 31. The sound generator 29 provides data in MIDI format to generate a sound signal. The sound system 30 includes a D/A converter, an amplifier and a speaker. The D/A converter converts a digital sound signal supplied from the CPU 21 into an analog sound signal and outputs the analog sound signal. The amplifier amplifies the analog sound signal output from the D/A converter. The speaker converts the analog sound signal amplified by the amplifier into sound and outputs the sound.

FIG. 7 shows a functional configuration of the server apparatus 10. The communication interface 14 functions as a receiver 41 and a transmitter 42. The CPU 11 functions as an acquisition unit 43, a processor 44 and a transmission controller 45. The acquisition unit 43, processor 44 and transmission controller 45 are implemented by executing programs by the CPU 11. The receiver 41 receives control data that indicates sound processing performed on content data corresponding to music from the client device 20. The acquisition unit 43 acquires content data corresponding to a sound processing target. The processor 44 performs sound processing, indicated by the control data received through the receiver 41, on content data 18 acquired by the acquisition unit 43. The storage unit 17 stores the content data acquired by the acquisition unit 43 as unprocessed content data while matching or linking the content data to a song ID that identifies the acquired content data, and also stores content data on which processing has been performed by the processor 44 as processed content data. When the client device 20 requests content data that represents music for editing of the music, the transmission controller 45 controls the transmitter 42 to transmit unprocessed content data, which is matched or linked to a song ID representing the content data and stored in the storage unit 17, to the client device 20. Furthermore, when the client device 20 requests control data that represents music for playback of the music, the transmission controller 45 transmits processed content data, which is also matched to a song ID representing the content data and stored in the storage unit 17, to the client device 20.

2. Operation

(1) Playback Process

A user can download content data 18 stored in the server apparatus 10 and play back music corresponding to the content data 18 through the client device 20A. FIG. 8 is a sequence chart illustrating a music playback process. In the music playback process, it is assumed that the user downloads the content data 18 representing the music m1 and plays back the music m1. The user instructs the client device 20A to display a content list screen 60 provided by the server apparatus 10 using the manipulation unit 25 of the client device 20A. Namely, the client device 20A accesses the server apparatus 10 according to instruction of the user and displays the content list screen 60 provided by the server apparatus 10 on the display 26.

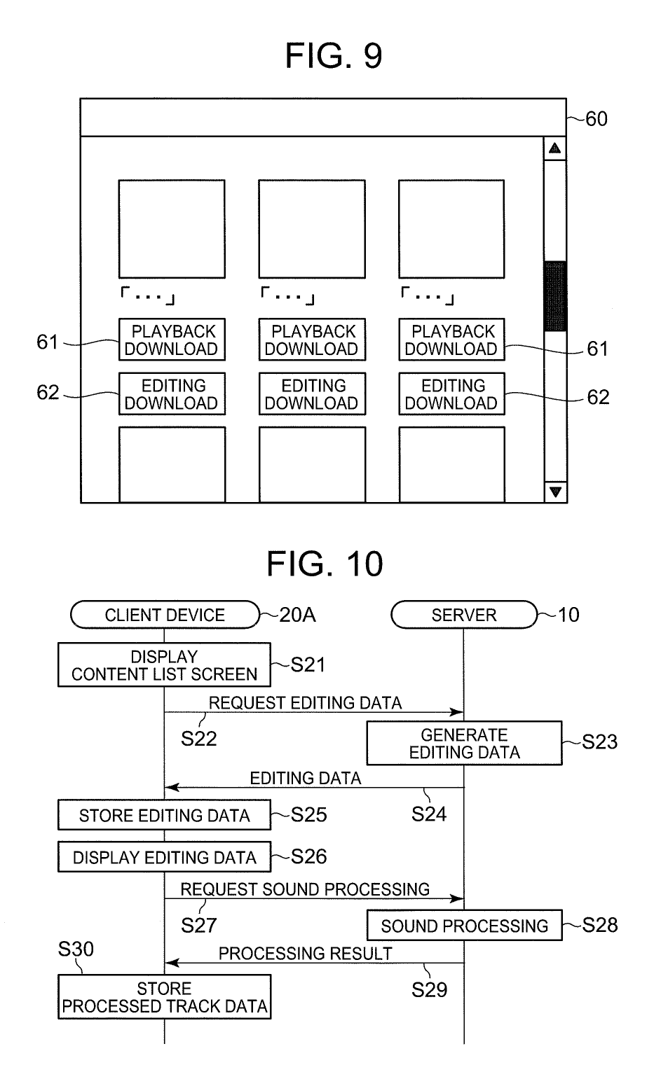

FIG. 9 shows an example of the content list screen 60. The content list screen 60 displays a list of content data 18 stored in the server apparatus 10. A playback download button 61 and an editing download button 62 are provided to the content list screen 60 as a control for selection. The playback download button 61 is a control by which data in a format suitable for playback is downloaded. The editing download button 62 is another control by which data in a format suitable for editing is downloaded. Upon display of the content list screen 60, the user selects the content data 18 corresponding to the music m1 using the manipulation unit 25 and pressing the playback download button 61.

Returning to FIG. 8, upon pressing the playback download button 61, the client device 20A requests the server apparatus 10 to provide playback data of the music m1 (step S12). That is, the client device 20A requests the server apparatus 10 to provide the content data 18 representing the music m1 in order to play back the music m1. The CPU 11 of the server apparatus 10 generates the playback data of the music m1 at the request of the client device 20A (step S13). The first song information 101 shown in FIG. 3 includes the song ID of the music m1. In this case, the CPU 11 reads the first music data 125 representing the music m1 from the link of the first song information 101. The CPU 11 compresses the read first music data 125 to create the playback data of the music m1. The playback data includes information that represents a data list included in a file. When the playback data of the music m1 was previously requested and generated, the CPU 11 may use the playback data of the music m1 stored in the storage unit 17 rather than creating the playback data of the music m1. The CPU 11 controls the communication interface 14 to transmit the playback data of the music m1 to the client device 20A (step S14). Upon reception of the playback data of the music m1 from the server apparatus 10, the CPU 21 of the client device 20A extracts the first music data 125 from the received playback data. The CPU 21 plays back the music m1 corresponding to the extracted first music data 125 using the sound generator 29 and sound system 30 (step S15). Accordingly, the music m1 is output from the sound system 30.

(2) Editing Process

The user can edit music through the client device 20A (e.g. first terminal device) using content data 18 downloaded from the server apparatus 10. FIG. 10 is a sequence chart illustrating a music editing process. In the music editing process, it is assumed that the user edits the music m1 using the content data 18 corresponding to the music m1. The user instructs the client device 20A to display the content list screen 60 provided by the server apparatus 10. Namely, the client device 20A accesses the server apparatus 10 according to instruction of the user and displays the content list screen 60 on the display 26 (step S21). Upon display of the content list screen 60, the user selects the content data 18 representing the music m1 by using the manipulation unit 25 and pressing the editing download button 62.

Upon pressing the editing download button 62, the client device 20A requests the server apparatus 10 to provide editing data of the music m1 (step S22). That is, the client device 20A requests the server apparatus 10 to provide the content data 18 representing the music m1 in order to edit the music m1. The CPU 11 of the server apparatus 10 generates the editing data of the music m1 at the request of the client device 20A (step S23). The first song information 101 shown in FIG. 3 includes the song ID of the music m1. In addition, the first song information 101 includes the link to the first track information 111 and the link to the second track information 112. In this case, the CPU 11 reads the unprocessed track data 121 from the link of the first track information 111 and reads the first control data from the first track information 111. In addition, the CPU 11 reads the unprocessed track data 123 from the link of the second track information 112 and reads the second control data from the second track information 112. The CPU 11 compresses the read unprocessed track data 121, the first control data, the unprocessed track data 123 and the second control data into one file to generate the editing data of the music m1. This editing data includes information that represents a list of data included in the file. Upon generation of the editing data of the music m1, the CPU 11 controls the communication interface 14 to transmit the created editing data to the client device 20A (step S24). The client device 20A receives the editing data of the music m1 from the server apparatus 10 and stores the received editing data in the storage unit 27 (step S25).

When the editing download button 62 is pressed, the client device 20A accesses the server apparatus 10 and displays an editing screen 70 provided by the server apparatus 10 on the display 26. Upon download of the editing data of the music m1 from the server apparatus 10, the client device 20A displays the editing data of the music m1 stored in the storage unit 27 on the editing screen 70 (step S26).

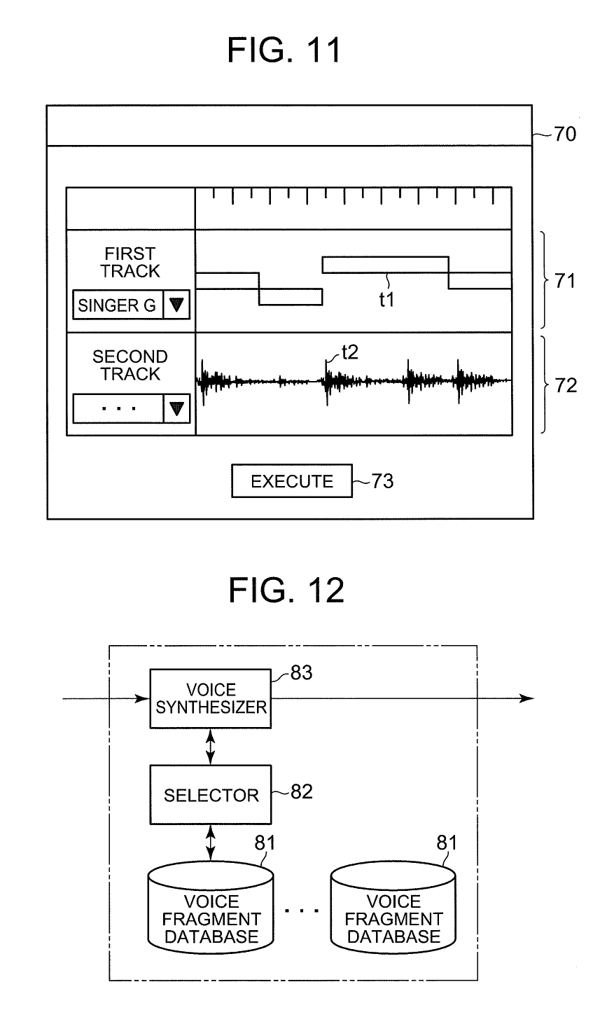

FIG. 11 shows an example of the editing screen 70. The editing screen 70 includes a first area 71 in which information about the first track is displayed and a second area 72 in which information about the second track is displayed. The first area 71 displays the unprocessed track data 121. The unprocessed content data 121 is score information t1 in MIDI format, which represents the score of the song part of the music m1. Furthermore, the first area 71 displays a type of voice synthesis processing indicated by the first control data, ‘singer G’. The second area 72 displays the unprocessed track data 123. The unprocessed track data 123 is audio data t2 of waveform representing the accompaniment part of the music m1. In addition, the second area 72 displays a type of effect processing indicated by the second control data. Upon display of the editing screen 70, the user edits the music using the manipulation unit 25. In the present embodiment, it is assumed that the user changes the voice of a singer, used for voice synthesis processing set to the first track, from the voice of ‘singer G’ to the voice of ‘singer M’ and presses an execution button 73.

When the execution button 73 is pressed, the client device 20A reads the unprocessed track data 121, stored in the first track, that is, the score information t1, from the storage unit 27. Referring back to FIG. 10, the client device 20A transmits the read score information t1 and third control data that indicates voice synthesis processing using the voice of the singer M to the server apparatus 10 and requests the server apparatus 10 to perform sound processing (step S27). Since the unprocessed track data 123 of the accompaniment part is not changed, the unprocessed track data 123 is not transmitted to the server apparatus 10. The CPU 11 of the server apparatus 10 performs sound processing on the basis of the score information t1 received through the communication interface 14 and the third control data at the request for sound processing (step S28). The third control data indicates voice synthesis processing using the voice of the singer M. In this case, the CPU 11 performs voice synthesis using the voice of the singer M on the basis of the score information t1 according to the third control data.

FIG. 12 illustrates voice synthesis processing. A voice fragment database 81 with respect to each singer is stored in the storage unit 17 of the server apparatus 10. The voice fragment database 81 stores a plurality of voice fragments obtained by sampling the voice of each singer. The storage unit 17 stores a voice synthesis program. The CPU 11 implements functions of a selector 82 and a voice synthesizer 83 by executing the voice synthesis program. The selector 82 selects the voice fragment database 81 corresponding to the singer M according to the third control data. The voice synthesizer 83 converts the score information t1 into audio data using the voice fragment database 81 selected by the selector 82. Specifically, the voice synthesizer 83 selects voice fragments from the voice fragment database 81 according to the score information t1, adjusts pitches and tones of the voice fragments and connects the voice fragments to generate audio data representing a synthesized singing voice.

Returning again to FIG. 10, when sound processing has been performed, the CPU 11 controls the communication interface 14 to transmit the audio data representing the synthesized voice, which is generated according to sound processing, to the client device 20A (step S29). Upon reception of the audio data representing the synthesized voice from the server apparatus 10, the client device 20A stores the received audio data as second processed track data 126 of the song part with the third control data in the storage unit 27 (step S30).

(3) Registration Process

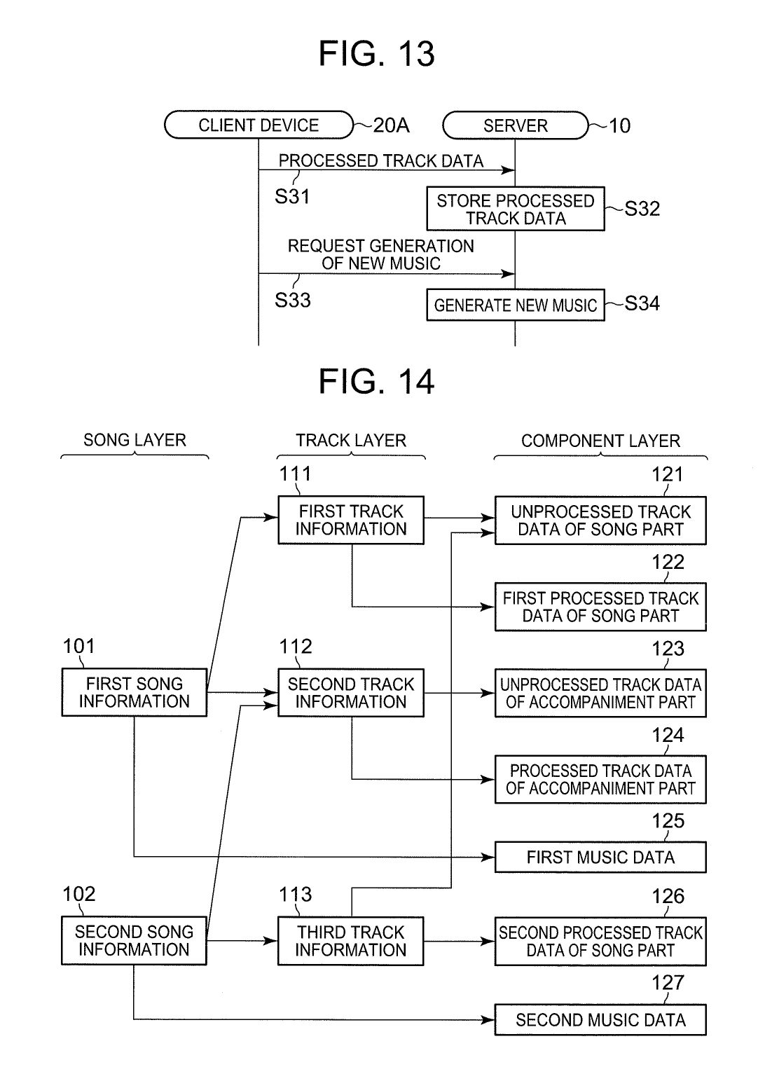

The user can register content data 18 corresponding to edited music in the server apparatus 10. FIG. 13 is a sequence chart illustrating a music registration process. In the music registration process, it is assumed that the user edits the music m1 to generate new music m2 and registers content data 18 corresponding to the generated music m2 in the server apparatus 10. The content data 18 is multi-track data composed of track data stored in the second track and track data stored in a third track. The track data corresponding to the accompaniment part of the music m1 is stored in the second track. Track data corresponding to the song part after editing is stored in the third track. Voice synthesis using the voice of the singer M is set as sound processing performed on the track data to the third track.

The user instructs the client device 20A to upload the second processed track data 126 and the third control data, which are stored in the storage unit 27 in step S30, to the server apparatus 10 using the manipulation unit 25 of the client device 20A. The client device 20A reads the second processed track data 126 and the third control data from the storage unit 27 according to instruction of the user and transmits the read second processed track data 126 and the third control data to the server apparatus 10 (step S31). Upon reception of the second processed track data 126 and the third control data through the communication interface 14, the CPU 11 of the server apparatus 10 stores the received data in the storage unit 17 (step S32).

The user inputs composition information of the music m2 using the manipulation unit 25 of the client device 20A and instructs the client device 20A to create new music. The content data 18 corresponding to the music m2 is composed of the second processed track data 126 of the song part and the processed track data 124 of the accompaniment part. In this case, the composition information of the music m2 includes information that designates the second processed track data 126 and the processed track data 124. The client device 20A transmits the component information of the music m2 input by the user to the server apparatus 10 and requests creation of new music (step S33). The CPU 11 of the server apparatus 10 creates the new music on the basis of the component information of the music m2, which is received through the communication interface 14 (step S34).

FIG. 14 shows a management structure of content data 18. FIG. 14 shows a management structure of the content data 18 corresponding to the music m1 and a management structure of the content data 18 corresponding to the music m2. In a process of generating new music, the second processed track data 126, received from the client device 20A, is added to the component layer. In addition, second music data 127 that represents the music m2 is added to the component layer. The second music data 127 is obtained by mixing the second processed track data 126 and the processed track data 124. Third track information 113 is added to the track layer. The third track information 113 includes a third track ID for identifying the third track and the third control data that represents voice synthesis processing set to the third track. The third track information 113 includes a link to the unprocessed track data 121 and a link to the second processed track data 126. Second song information 102 is added to the song layer. The second song information 102 includes a second song ID for identifying the music m2.

That is, the storage unit 17 stores the song ID (e.g. content identification information) of the music m2, the second track ID and the third track ID (e.g. track identification information), the unprocessed track data 121 of the song part and the unprocessed track data 123 of the accompaniment part (e.g. unprocessed track data), the second processed track data 126 of the song part and the processed track data 124 of the accompaniment part (e.g. processed track data), and the second control and the third control data (e.g. indication information) in a corresponding manner. The second song ID and the third track ID may be input by the user or determined by the CPU 11. In this manner, the content data 18 corresponding to the music m2 is registered in the server apparatus 10.

After the content data 18 corresponding to the music m2 is registered in the server apparatus 10, if the client device 20B (e.g. second terminal device) requests playback data of the music m2, the sever device 10 generates the playback data including the second music data 127 (e.g. track data corresponding to a mixture of a plurality of processed track data items) according to the above-mentioned method and transmits the playback data to the client device 20B. When the client device 20B request editing data of the music m2, the server apparatus 10 creates editing data including the unprocessed track data 121 of the song part, the unprocessed track data 123 of the accompaniment part (both being unprocessed track data, for example), the second control data and the third control data (both being indication information, for example) and transmits the editing data to the client device 20B.

The user may download editing data or playback data of the music m2 created by the user by manipulating the client device 20A. That is, a client device 20 (exemplary first terminal device) that requests the server apparatus 10 to perform sound processing and a client device 20 (exemplary second terminal device) that downloads editing data or playback data of music from the server apparatus 10 may be the same client device 20.

In the present embodiment, when the user presses the editing download button 62, editing data of music is downloaded from the server apparatus 10. The editing data has a structure in which a multi-track state is maintained, and thus editing of each track is easily performed. In the present embodiment, when the user presses the playback download button 61, playback data of music is downloaded from the server apparatus 10. Since the playback data is audio data that represents the music, it is easy to reproduce the playback data. In this manner, data in different formats are downloaded in a case in which data is downloaded for playback and a case in which data is downloaded for editing, and thus content is easily played back and edited. Easy editing of content can promote secondary work of content.

In the present embodiment, the control data is described in addition to the track data, and editing data including the control data is downloaded from the server apparatus 10 when the user downloads data for editing. Accordingly, the user can easily edit content simply by changing sound processing indicated by the control data on the editing screen 70. Particularly, change of sound processing is needed for secondary work of content. Accordingly, easy change of sound processing can promote secondary utilization of content.

In the present embodiment, when content data 18 corresponding to new music is registered in the server apparatus 10, data previously stored in the storage unit 17, for example, the second track information 112, the unprocessed track data 121, the unprocessed track data 123 and the processed track data 124, shown in FIG. 14, are not stored and only links to the data are added to the storage unit 17. Accordingly, it is possible to reduce the capacity of the storage unit 17 of the server apparatus 10, compared to a case in which the data is stored.

3. Modifications

The present invention is not limited to the above-described embodiment. The embodiment may be modified as follows. Furthermore, the following modifications may be combined.

(1) Modification 1

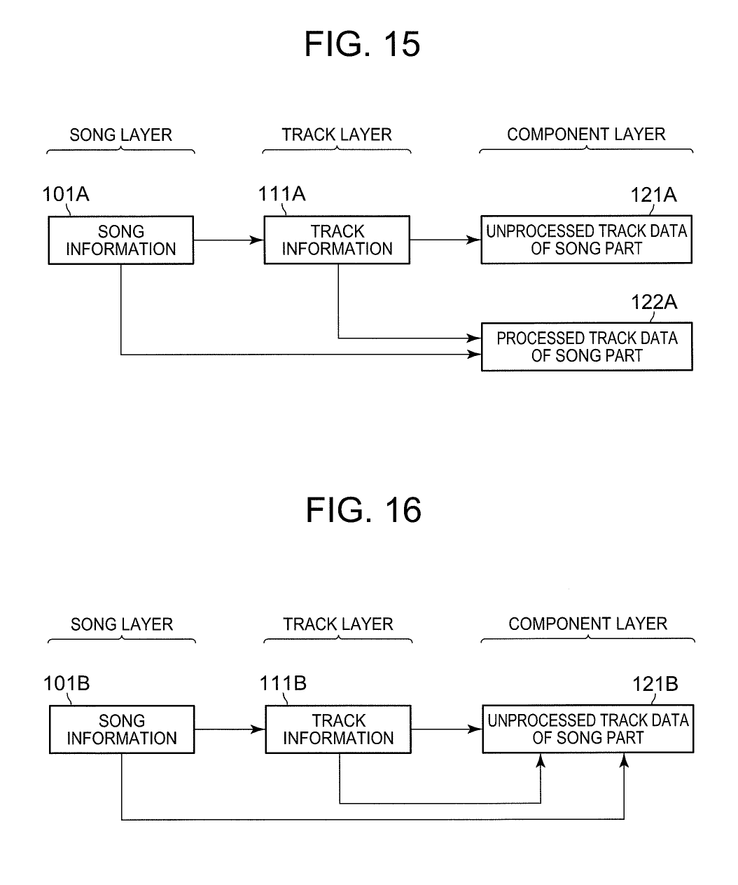

The content data 18 that represents music is not limited to multi-track data. The content data 18 that represents music may be stored in a single track. FIG. 15 shows a management structure of the content data 18 according to modification 1. FIG. 15 shows the management structure of content data 18 corresponding to music m3. The content data 18 is composed of track data stored in a single track. The track stores track data of a song part of the music m3. In this case, unprocessed track data 121A and processed track data 122A of the song part are stored in the component layer. Since the processed track data 122A corresponds to audio data representing the music m3, music data representing the music m3 is not stored. Song information 101A includes a link to the processed track data 122A.

When the client device 20 requests playback data of the music m3, the server apparatus 10 creates playback data including the processed track data 122A and transmits the playback data to the client device 20. In this case, the processed track data 122A is handled as processed content data representing the music m3. When the client device 20 requests editing data of the music m3, the server apparatus 10 generates editing data including the unprocessed track data 121A and transmits the editing data to the client device 20. In this case, the unprocessed track data 121A is handled as unprocessed content data 18 that represents the music m3.

(2) Modification 2

Processed track data may not need to be stored. For example, a process for changing volume is low-load processing and can be easily performed by the client device 20, and thus it is not necessary for the server apparatus 10 to perform the process. When sound processing set to a track is a process predetermined in this manner, processed track data may not be stored. FIG. 16 shows a management structure of content data 10 according to modification 2. In FIG. 16, a management structure of content data 18 corresponding to music m4 is shown. The content data 18 is composed of track data stored in a single track. The track stores track data corresponding to a song part of the music m4. Processing for changing the volume of the song part of the music m4 is set as sound processing performed on the track data to the track. In this case, only unprocessed track data 121B of the song part is stored in the component layer. The unprocessed track data 121B is track data before the volume of the song part is changed. Song information 101B and track information 111B include a link to the unprocessed track data 121B of the song part.

For example, when the client device 20 requests editing data of the music m4, the server apparatus 10 creates editing data including the unprocessed track data 121B of the song part and transmits the editing data to the client device 20. In this case, the unprocessed track data 121B of the song part is handled as unprocessed content data 18 corresponding to the music m4. According to modification 2, data capacity is reduced because track data after the volume of the song part is changed is not stored in the component layer.

Furthermore, unprocessed track data as well as processed track data may not be stored.

(3) Modification 3

Editing of music is not limited to the examples described in the embodiment. For example, a process of applying reverberation to track data can be set. In this case, the client device 20 transmits control data that indicates the process of applying reverberation to the server apparatus 10. The server apparatus 10 applies reverberation to the corresponding track data according to the control data. Furthermore, a process of converting track data into audio data in a specific sound generator may be set. In this case, the client device 20 transmits control data that indicates the process of converting track data into audio data in the specific sound generator to the server apparatus 10. The server apparatus 10 converts the track data into the audio data by means of the specific sound generator according to the control data. Editing of music may correspond to cutting or repetition of part of music.

(4) Modification 4

Information that identifies unprocessed track data may be matched to processed track data and stored in the component layer. For example, the file name and identifier of unprocessed track data can be used as the information for identifying the unprocessed track data. Accordingly, it is possible to recognize the corresponding relationship between the unprocessed track data and the processed track data.

(5) Modification 5

The configuration of content data 18 that represents music is not limited to the embodiment. For example, the content data 18 may include track data that represents lyrics. This track data indicates text data representing the lyrics and data representing timing of the lyrics. For example, the user can change the lyrics of music by changing words represented by the track data on the editing screen 70. In the above-described embodiment, the accompaniment part is stored in a single track. However, when the accompaniment part is composed of sounds of a plurality of musical instruments such as a guitar, a flute, a drum, etc., parts of these musical instruments may be respectively stored in different tracks.

(6) Modification 6

In the above-described embodiment, the server apparatus 10 receives track data from the client device 20 and performs sound processing on the track data. However, when the track data that becomes a sound processing target is stored in the server apparatus 10, the server apparatus 10 may read the track data from the storage unit 17 and perform sound processing on the track data. That is, the server apparatus 10 may acquire data corresponding to a sound processing target from the client device 20 or the storage unit 17. In this case, the client device 20 need not transmit the track data to the server apparatus 10.

(7) Modification 7

Editing data may include control data. In this case, only the control data is displayed on the editing screen 70.

(8) Modification 8

When content data 18 is registered, whether download is permitted may be set. Here, it is possible to set such that only one of download for editing or download for playback is permitted. The server apparatus 10 determines whether to perform download on the basis of setting whether to permit download. When download is not permitted, transmission of data is not performed.

(9) Modification 9

Content data 18 corresponding to music may be downloaded in the unit of track data. For example, when only the song part of the music m1 is played, the client device 20 requests playback data of the song part to the server apparatus 10. In this case, the server apparatus 10 generates playback data including the first processed track data 122 and transmits the playback data to the client device 20. If only the song part of the music m1 is edited, the client device 20 requests editing data of the song part to the server apparatus 10. In this case, the server apparatus 10 creates editing data including the unprocessed track data 121 and first control data and transmits the editing data to the client device 20.

(10) Modification 10

Content data 18 registered in the server apparatus 10 is not limited to data representing music. The content data 18 may be generated by the user and electronically handled. For example, the content data 18 can represent an image or a combination of an image and music. In this case, the CPU 11 may perform video processing on the content data 18. Furthermore, the content data 18 may be an e-book.

(11) Modification 11

The functions of the server apparatus 10 may be implemented by a plurality of devices. For example, a first device that performs sound processing and a second device that stores content data 18 may be provided. In this case, the first device performs the above-described steps S28 and S29. The second device performs processing other than the steps S28 and S29. Here, the first device and the second device may exchange necessary information to cooperate with each other for processing.

(12) Modification 12

The program executed by the CPU 11 of the server apparatus 10 or the CPU 21 of the client device 20 may be stored in a non-transitory recording medium such as a magnetic tape, a magnetic disk, a flexible disc, an optical disc, an optical magnetic disc, a memory, etc. and installed in the server apparatus 10 or the client device 20. Furthermore, the program may be downloaded to the server apparatus 10 or the client device 20 through a communication line such as the Internet.

(13) Modification 13

The data format of the track data 121 to 125 is not limited to the format described in the embodiment. For example, the unprocessed track data 121 may be XML (Extensible Markup Language) data instead of MIDI.

What is claimed is:

1. An apparatus for providing content to terminal devices, comprising:
a receiver configured to receive from a first terminal device indication information that indicates processing to be performed on content data representing content;
an acquisition unit configured to acquire content data of the content as a processing target;
a processor configured to perform the processing indicated by the indication information received by the receiver on the content data acquired by the acquisition unit;
a storage unit configured to identify the content data acquired through the acquisition unit by identification information, and configured to store the content data in correspondence to the identification information as unprocessed content data and to store the content data on which the processing has been performed as processed content data; and
a transmission controller configured to transmit the unprocessed content data identified by the identification information to a second terminal device when the second terminal device requests the content data representing the content in order to edit the content.

2. The apparatus according to claim 1, wherein the transmission controller is configured to transmit the processed content data being identified by the identification information and being stored in the storage unit to the second terminal device when the second terminal device requests the content data representing the content in order to play back the content.

3. The apparatus according to claim 1, wherein
the storage unit is configured to associate the indication information with the identification information of the content data on which the processing indicated by the indication information is performed and configured to store the indication information in correspondence to the identification information, and wherein
the transmission controller is configured to transmit to the second terminal device the content data as unprocessed content data together with the indication information corresponding to the identification information identifying the content data stored in the storage unit and requested by the second terminal device.

4. The apparatus according to claim 1, wherein
the content data is composed of a plurality of pieces of track data representing a plurality of tracks of the content, and the indication information indicates processing performed on the track data, wherein
the processor is configured to perform the processing indicated by the indication information on the track data constituting the content data acquired by the acquisition unit, wherein
the storage unit is configured to identify the track data by track identification information, and configured to store the track data as unprocessed track data in correspondence to the track identification information and to store the track data on which the processing indicated by the indication information is performed as processed track data, and wherein
the transmission controller is configured to transmit, to the second terminal device, the unprocessed track data constituting the content data when the second terminal device requests the content data representing the content in order to edit the content, and configured to transmit data corresponding to a mixture of the processed track data identified by the track identification information and stored in the storage unit when the second terminal device requests the content data representing the content in order to play back the content.

5. The apparatus according to claim 4, wherein the content data represents music and the plurality of track data represents a plurality of parts of the music.

6. A terminal device for editing content data representing content provided from a server apparatus, comprising:
a graphical user interface configured to display a control enabling a user to select either of editing or playback of content;
a communication interface configured to transmit a first request to the server apparatus when the editing of the content is requested by the user and to receive first content data of the content from the server apparatus in response to the first request, and configured to transmit a second request to the server apparatus when the playback of the content is requested by the user and to receive second content data of the content from the server apparatus in response to the second request, the first content data and the second content data representing the same content but respectively having a first format and a second format different from each other, the first format being designed for editing of the content and the second format being designed for playback of the same content;
an editing unit configured to edit the first content data of the first format displayed on the graphical user interface when the editing of the content is selected, and configured to upload the edited first content data to the server apparatus; and
a playback unit configured to play back the second content data of the second format when the playback of the same content is selected.

7. The terminal device according to claim 6, wherein
the communication interface is configured to receive the first content data that is composed of a plurality of track data representing a plurality of tracks of the content, and wherein
the editing unit is configured to selectively edit one or more of the plurality of track data and configured not to edit the remaining track data, and is configured to upload only the edited track data and to notify the server apparatus of the remaining track data.

8. A method of providing content to terminal devices, comprising:
receiving from a first terminal device indication information that indicates processing to be performed on content data representing content;
acquiring content data of the content as a processing target;
performing the processing indicated by the indication information on the content data;
identifying the content data by identification information;
storing the content data in correspondence to the identification information as unprocessed content data;
storing the content data on which the processing has been performed as processed content data; and
transmitting the unprocessed content data identified by the identification information to a second terminal device when the second terminal device requests the content data in order to edit the content.

9. A machine readable non-transitory recording medium for use in a server apparatus for providing content to terminal devices, the medium containing program instructions executable by the server apparatus for performing the steps of:
receiving from a first terminal device indication information that indicates processing to be performed on content data representing content;
acquiring content data of the content as a processing target;
performing the processing indicated by the indication information on the content data;
identifying the content data by identification information;
storing the content data in correspondence to the identification information as unprocessed content data;
storing the content data on which the processing has been performed as processed content data; and
transmitting the unprocessed content data identified by the identification information to a second terminal device when the second terminal device requests the content data in order to edit the content.
